(19) United States
(12) Patent Application Publication
(10) Pub. No.: US 2003/0235493 A1
(43) Pub. Date: Dec. 25, 2003

(54) Wind turbine with tensile-type structure

(76) Inventor: Daryoush Keyvani, West Hills, CA (US)

Correspondence Address: DARYOUSH KEYVANI, 22673 CRISWELL ST., WEST HILLS, CA, 91307, US

(21) Appl. No.: 10/417,288

(22) Filed: Apr. 17, 2003

Related U.S. Application Data
(60) Provisional application No. 60/385,458, filed on Jun. 4, 2002.

(51) Int. Cl. F03D 7/00

(52) U.S. Cl. 415/4.1

(57) ABSTRACT

As compared to a conventional wind turbine, in the turbine utilized in this invention, one or more large external ring exists at the end-point of the blades. These rings are firmly connected, in an X-shaped construct, to the end-point of the central axle, by way of a system of truss-type tensile cables. Other paired cables, extended from the large external ring, are connected to the mid-point of the central axle. The sheets, which cover these paired cables, constitute the stretched blades. The said paired cables are installed, in oblique angle relative to the surface of the ring, so that the wind current would push them in a direction opposite to the angle of pressure. The set of these stretched blades, that fill the space between the large ring and the central angle, constitute the wind turbine.

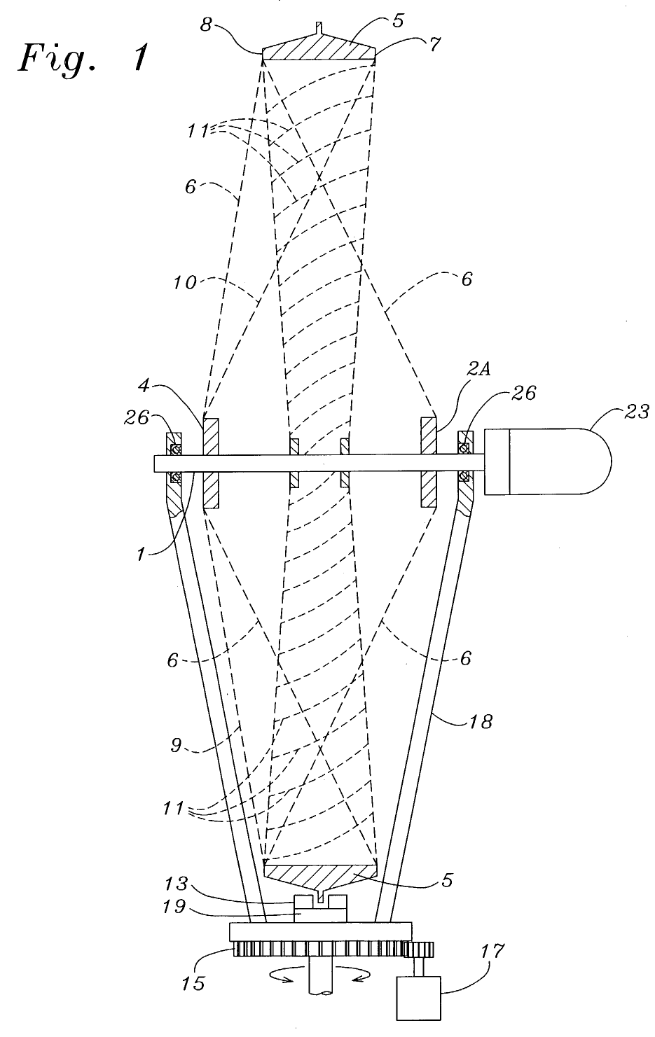

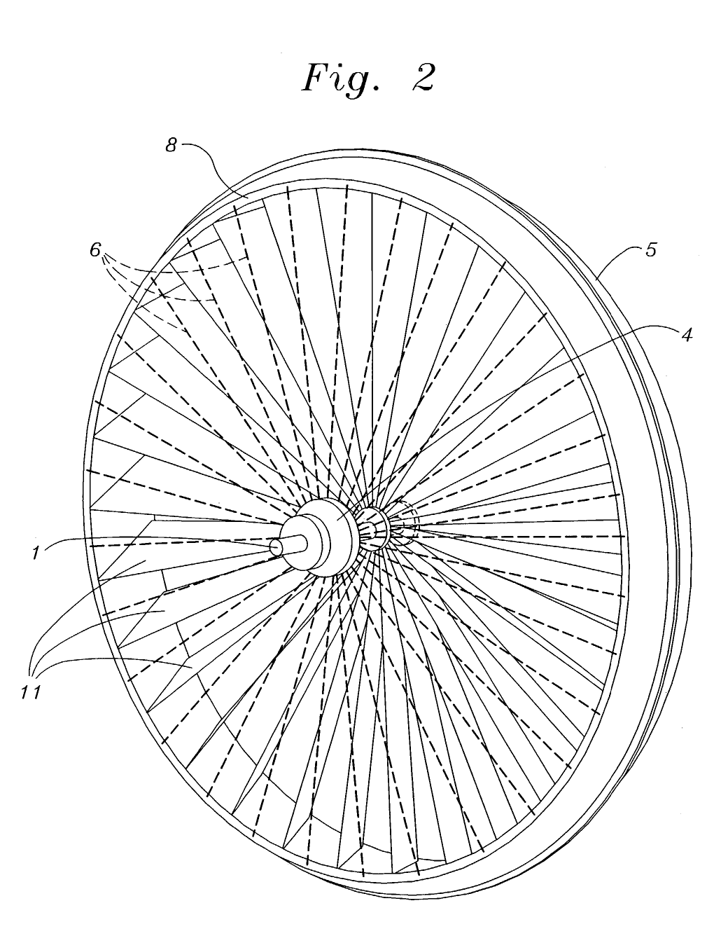

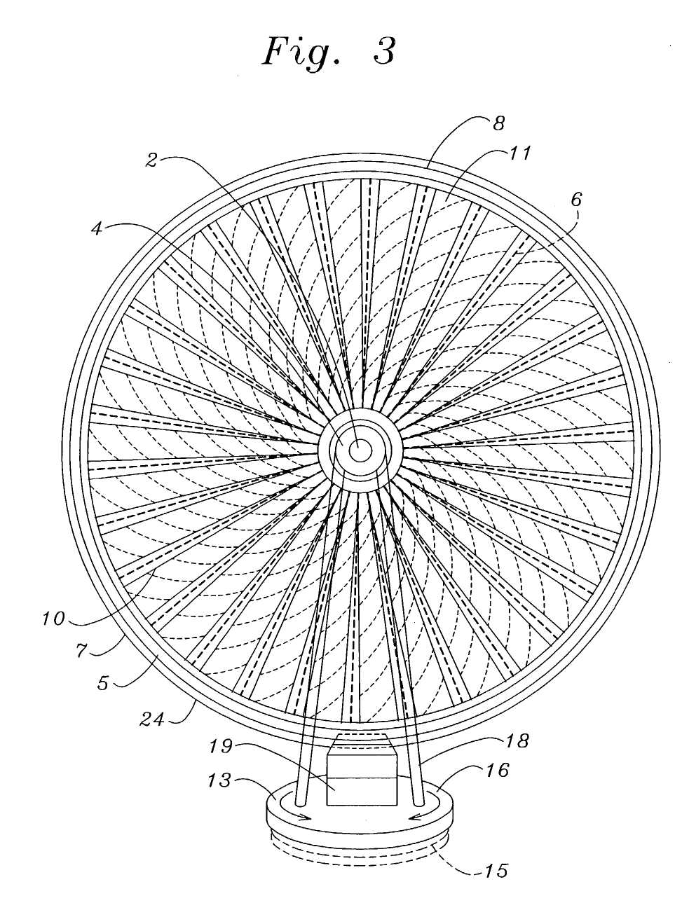

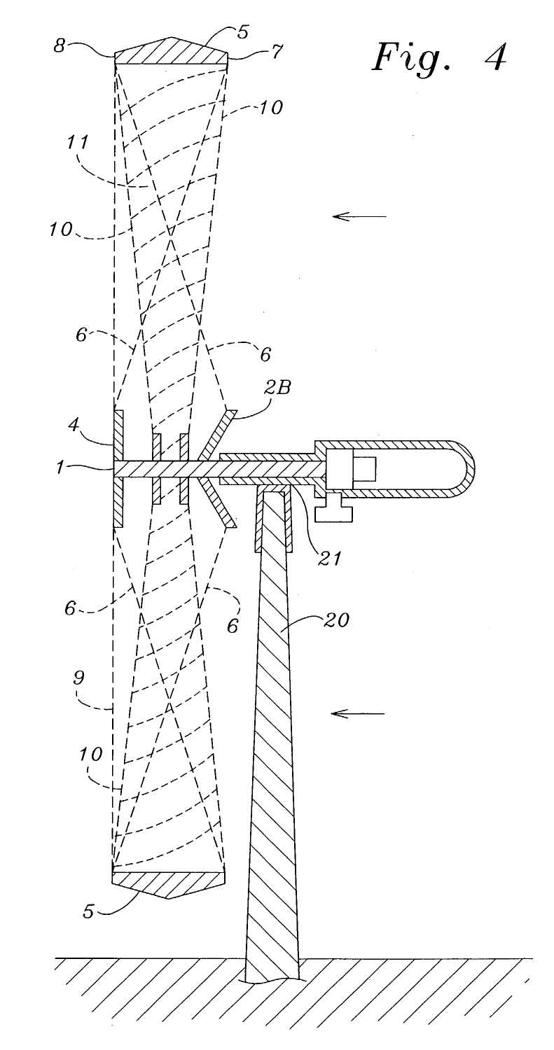

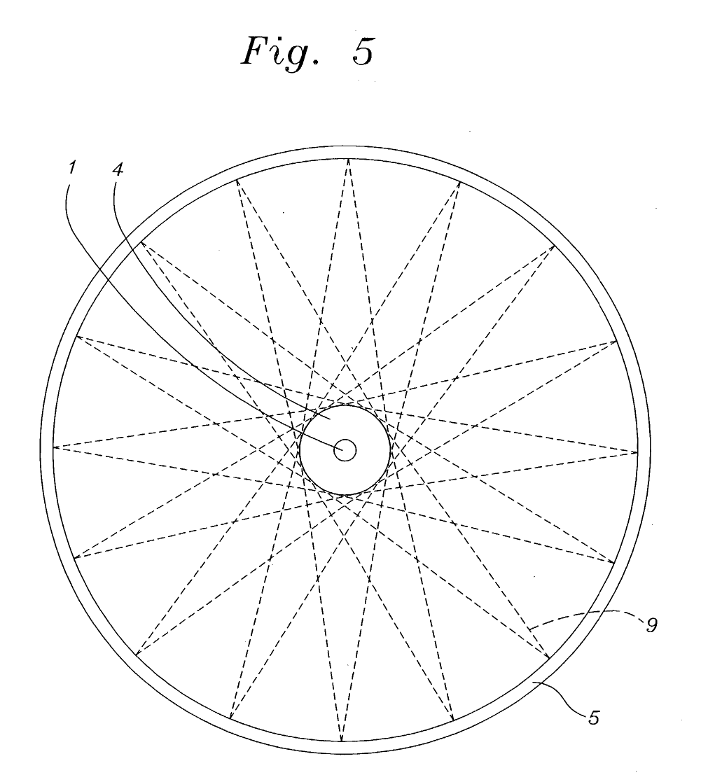

This application form is submitted pursuant to the previous provisional file, No. 60385458, dated Jun. 4, 2002, by myself under the following name: Turbines generating energy from wind by blades, which are stretched between rings through two up and down connections.

### BACKGROUND

In conventional turbines, which are constructed on the basis of a propeller to convert the force of wind to usable energy, each blade is connected to the axle of The turbine at one connection point only. Consequently, a lever force is added to the force of wind. As a result, such blades need to be constructed thickly and with material of high solidity. This would necessitate a high construction cost, as well as high volume of materials.

The main idea presented in The wind turbine with tensed structure is that at the expense of adding a large external ring, and firmly connecting it—by means of a cable—to the two end points of the axle of the turbine, another connection point for the second end point of the blades is created at the location of the large ring. Thus, any sheet of thick fabric, or other material, that is installed over a pair of tensed cables can replace the above mentioned thick and expensive blades.

In other words, due to its truss property, and the V-shape (in version 1) basis of this turbine, it exerts a much higher level of resistance against storms, as compared to the vertical pillars of conventional turbines. And the electrical engine, which is engaged with the circular basis under the pillar, has two conflicting, but complementary, duties:

1—During normal conditions it adapts the direction of the turbine to the wind direction in order to achieve higher efficiency.

2—During storms and very intense winds it limits the angle of turbine with respect to the wind direction, so that a force greater than the permissible limit of firmness and resistance of the apparatus is not imposed on it.

It should be obvious that an apparatus containing a speedometer and also a device capable of pinpointing the wind direction would transmit its gathered information to an electronic device, capable of relaying appropriate signals to the electrical engine.

The stretched cables that connect the external ring, in truss-type manner, to the small rings provide sufficient firmness to the external ring, at a much lower cost. In this way a desirable space is generated between the external ring and The axis of The pair of small ring, which cam be used to install the tensile blades. This is due to the fact that under such a mechanism, the blades are attached at their two extreme top and bottom points, as opposed to only one connection point in the case of conventional turbines.

Any kind of sheet can be used to cover the blades of this invention, and the set of blades can cover The whole internal surface of the large ring to optimally utilize this surface and significantly increase its productivity as a complete turbine.

The main parts of this apparatus are as follows:

at the center of this turbine there is an axle 1, which is connected to the gearbox and the generator. On top of the axle and close to its head, a ring 2 is initially installed, and on The other ind of the axle is a flat ring 4 is installed.

The main large ring 5 is positioned at a farther distance from rings 2 and 4. The large ring 5 is connected to rings 2 and 4—or to axle 1 itself—via either of the following three types of stretched cables.

I. The first type of stretched cable is a truss cable 6 that extends from the internal ring 2 and is connected to ring 5 at side 8 which is over ring 4. Also, across from it, from the ring at the extreme 4 it is connected to ring 5 at side 7, which is over 2. This connecting cable, which is called a truss, always keeps rings 2, 4, and 5 firm and parallel to each other. It should be noted that the (initial) ring version 1 is flat, while the 11 same ring in version 2 is oblique.

II. The second type of stretched cable 9 connects the main ring 5 from the end side 8 to the last ring 4. The angle at the point where such cables are connected to rings 4 and 5 is not right angled. It extends in the two directions at each connection point. The purpose to use such a cable is to keep the angle of rotation of rings 4 and 5 constant.

III. The third type of stretched cable 19, which extends from the main ring to the axle of the turbine 1, is in fact a pair of cables. The connection point of the cables to ring 5 is side 7, i.e. the entry (or initial) direction. The other stretched cable is extended from side 8, i.e. the exit (or terminating) direction towards axle 1. Due to the fact that the connection points of the cable on the two sides of the ring are not symmetrical to each other, the sheet and plates that are installed over these stretched cables take an oblique angle with respect to the surface of the ring, which are stretched blades 11, so that their totality constitutes the wind turbine 12.

The main body of turbine can be laid over two different types of pillars, thus providing two versions of the apparatus.

In version 1, a circular plate 13 is installed inside a ring 14, and parallel to the ground. This plate, which consists of two layers, is rotatable inside the ring. The first layer engages the ring similar to a bearing 15. But the second layer has gears 16 which engage with the gears of an electric engine 17. This engine functions in a way to adjust the turbine with the direction of the wind and its intensity. The width of the circular plate is longer than the width of the large ring. From the sides of this plate, two or four V-shape pillars 18 are directed towards the sides of the axle of the turbine to keep it steady. The breaking device 19 of the turbine is installed over the plate, and if needed, it is capable of directly acting over the large ring and brings it to a halt.

In version 2, an immovable pillar 20, in the shape of a tower is installed on the ground. Over this tower, a T-shape part 21 is rotatable from the side of its pillar. The axle of this turbine enters into one side of the T-shape part. The gearbox and the turbine are installed on The other side of the T-shape part.

In the claims:

1. Please cancel claims 1 thru 15.
Please add the following claims:

16. (New) A horizontal axis wind turbine comprising:
a support structure,
a substantially horizontal axle; said axle having an axle first end and an axle second end, said axle first end being the into the wind end of said axle; said axle second end being the down wind end of said axle;
an annular outer ring; said annular outer having a ring first edge and a ring second edge, said ring first edge being the into the wind edge of said annular outer ring; said ring second edge being the down wind edge of said annular ring;
a plurality of turbine blades fastened at a first end to said axle and fastened at a second end to said annular outer ring; said turbine blades having a first blade cable and a second blade cable; said first blade cable fastened at a first end to said axle and at a second end to said annular outer ring; said second blade cable fastened at a first end to said axle and at a second end to said annular outer ring;
a sheet material fastened between said first blade cable and said second blade cable so that a turbine blade is formed therebetween, said turbine blades being designed so that said axle and said annular outer ring and said turbine blades rotate when said turbine blades are subjected to wind.

17. (New) The horizontal wind turbine of claim 16 wherein said blade cables of said turbine blades are tightened so that said blade cables have tension therein.

18. (New) The horizontal wind turbine of claim 16 wherein said support structure is substantially “T” shaped.

19. (New) The horizontal wind turbine of claim 16 wherein said support structure substantially rotates on a vertical axis.

20. (New) The horizontal wind turbine of claim 16 wherein wind turbine has a breaking device to prevent said wind turbine from rotating.

21. (New) The horizontal wind turbine of claim 16 wherein said axle has a generator means connected thereto for producing an electrical output relative to a rotation of said axle and said turbine blades.

22. (New) The horizontal wind turbine of claim 16 including a plurality of support cables, said support cables having a first end and a second end; said support cables fastened at said first end to said first edge of said annular outer ring and said support cables fastened at said second end near said second end of said axle.

23. (New) The horizontal wind turbine of claim 16 including a plurality of support cables, said support cables having a first end and a second end; said support cables fastened at said first end to said second edge of said annular outer ring and said support cables fastened at said second end near said first end of said axle.

24. (New) The horizontal wind turbine of claim 16 including a plurality of support cables, said support cables having a first end and a second end; said support cables fastened at said first end to said first edge of said annular outer ring and said support cables fastened at said second end near said first end of said axle.

25. (New) A horizontal axis wind turbine comprising:
a support structure,
a substantially horizontal axle; said axle having an axle first end and an axle second end, said axle first end being the into the wind end of said axle; said axle second end being the down wind end of said axle;
an annular outer ring; said annular outer having a ring first edge and a ring second edge, said ring first edge being the into the wind edge of said annular outer ring; said ring second edge being the down wind edge of said annular ring;
a plurality of turbine blades fastened at a first end to said axle and fastened at a second end to said annular outer ring; said turbine blades having a first blade cable and a second blade cable; said first blade cable fastened at a first end to said axle and at a second end to said annular outer ring; said first blade cable being tightened so that said first blade cable has tension therein; said second blade cable fastened at a first end to said axle and at a second end to said annular outer ring; said second blade cable being tightened so that said second blade cable has tension therein;
a sheet material fastened between said first blade cable and said second blade cable so that a turbine blade is formed therebetween, said turbine blades being designed so that said axle and said annular outer ring and said turbine blades rotate when said turbine blades are subjected to wind.

26. (New) The horizontal wind turbine of claim 25 wherein said support structure is substantially “T” shaped.

27. (New) The horizontal wind turbine of claim 25 wherein said support structure substantially rotates on a vertical axis.

28. (New) The horizontal wind turbine of claim 25 wherein wind turbine has a breaking device configured to prevent said wind turbine from rotating.

29. (New) The horizontal wind turbine of claim 25 wherein said axle has a generator means connected thereto for producing an electrical output relative to a rotation of said axle and said turbine blades.

30. (New) The horizontal wind turbine of claim 25 including a plurality of support cables, said support cables having a first end and a second end; said support cables fastened at said first 11 end to said first edge of said annular outer ring and said support cables fastened at said second end near said second end of said axle.

31. (New) The horizontal wind turbine of claim 25 including a plurality of support cables, said support cables having a first end and a second end; said support cables fastened at said first end to said second edge of said annular outer ring and said support cables fastened at said second end near said first end of said axle.

32. (New) The horizontal wind turbine of claim 25 including a plurality of support cables, said support cables having a first end and a second end; said support cables fastened at said first end to said first edge of said annular outer ring and said support cables fastened at said second end near said first end of said axle.
